(19) United States
(12) Patent Application Publication
(10) Pub. No.: US 2012/0143511 A1
(43) Pub. Date: Jun. 7, 2012

(54) REMOVING GROUND ROLL FROM GEOPHYSICAL DATA

(76) Inventors: DAVID FRASER HALLIDAY, CHERRY HINTON (GB); JOHN QUIGLEY, REIGATE (GB)

(21) Appl. No.: 13/287,809

(22) Filed: Nov. 2, 2011

Related U.S. Application Data
(63) Continuation-in-part of application No. 12/848,534, filed on Aug. 2, 2010.
(60) Provisional application No. 61/425,679, filed on Dec. 21, 2010.
(60) Provisional application No. 61/236,000, filed on Aug. 21, 2009.

(51) Int. Cl. G01V 1/28; G06F 19/00

(52) U.S. Cl. 702/17

(57) ABSTRACT

Methods and systems for processing geophysical data are disclosed. In one embodiment, interferometry and modeling are used to generate and then remove estimates of ground roll between a source and one or more boundary locations.

### CROSS-REFERENCE TO RELATED APPLICATIONS

This application claims benefit of U.S. provisional patent application Ser. No. 61/425,679 filed Dec. 21, 2010. This application is also a continuation-in-part of co-pending U.S. patent application Ser. No. 12/848,534 filed Aug. 2, 2010, which claims benefit of U.S. provisional patent application Ser. No. 61/236,000, filed Aug. 21, 2009. Each of the aforementioned related patent applications is herein incorporated by reference.

### BACKGROUND

1. Field of the Invention

Implementations of various technologies described herein generally relate to geophysical data processing.

2. Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Seismic exploration is conducted on both land and in water. In both environments, exploration involves surveying subterranean geological formations for hydrocarbon deposits. A survey typically involves deploying acoustic source(s) and acoustic sensors/receivers at predetermined locations. The sources impart acoustic waves into the geological formations. Features of the geological formation reflect the acoustic waves to the sensors. The sensors receive the reflected waves, which are detected, conditioned, and processed to generate seismic data. Analysis of the seismic data can then indicate probable locations of the hydrocarbon deposits.

However, not all of the acoustic waves propagate downward into the geological formation. Some of the acoustic waves are “interface waves” that propagate along an interface between two media instead of through a medium. An interface wave can travel at the interface between the Earth and air—e.g., surface waves—between the Earth and a body of water—e.g., Scholte waves—or between a shallow interface within the near-surface of the Earth—e.g., refracted shear waves. Surface waves or seismic waves that propagate laterally through the near surface of the Earth often create a “ground roll” in acquired seismic data. Ground roll is a type of coherent noise generated by a surface wave that can obscure signals reflected from the geological formation and degrade overall quality of the seismic data resulting from the survey. Consequently, most surveys attempt to eliminate, or at least reduce, ground roll. In the following, the term “ground roll” will be used in place of surface wave, as is common in the exploration seismology industry.

Techniques for mitigating ground roll include careful selection of source and geophone arrays during the survey and filters and stacking parameters during processing. However, because the ground roll can be heavily (back) scattered by near-surface heterogeneities, conventional frequency and wave number (“FK”)-filtering techniques are often unsuccessful: the noise is distributed over a large range of (out-of-plane) wave numbers outside the expected FK-slice in a manner that is difficult to predict without highly detailed knowledge of the near-surface scatterers.

The phenomenon of interface waves is described above in the context of seismic surveying. However, their existence is not limited to that technology. The phenomenon may also be encountered in electromagnetic surveying or non-destructive testing (i.e., geophysical data), for instance. Interface waves raise similar concerns and have similar effects on the efficacy of these technologies as well.

### SUMMARY

Described herein are implementations of various techniques for processing geophysical data. In one implementation, the method may include generating a model from geophysical data acquired at one or more receiver locations that are arranged in one or more substantially linear shapes. After generating the model, the method may apply a forward modeling algorithm using information from the model to generate an estimate of a ground roll between a source location and one or more boundary source locations. The method may then include determining one or more estimates of one or more ground rolls between one of the receiver locations and the boundary source locations. After determining the estimates of ground rolls, the method may apply interferometry between the estimates of the ground rolls between the one of the receiver locations and the boundary source locations and the estimate of the ground roll between the source location and the boundary source locations to generate an interferometric estimate of a ground roll between the source location and the one of the receiver locations. The method may then remove the interferometric estimate of the ground roll between the source location and the one of the receiver locations from geophysical data acquired at the one of the receiver locations. In one implementation, the method described above may be performed by a computer-readable medium or a computer system that has a processor, a memory and program instructions configured to perform the method.

In another implementation, the receiver locations may be arranged in a substantially grid pattern such that the substantially linear shapes may be substantially parallel. In another implementation, the boundary source locations may be arranged in one or more closed geometry configurations such that the boundary source locations form two or more concentric shapes. In yet another implementation, the boundary source locations may be arranged in one or more open geometry configurations or in one or more substantially linear shapes. In yet another implementation, the boundary source locations may be a subset of a plurality of source locations that may be arranged in a substantially grid pattern such that each source location in the plurality of source locations is adjacent to at least one of the receiver locations. In yet another implementation, the boundary source locations may form two or more concentric shapes. In yet another implementation, the boundary source locations may be arranged in the one or more substantially linear shapes. In yet another implementation, each receiver location may include a cluster of receivers such that the distance between each receiver in the cluster of receivers may be less than the distance between each receiver location. In yet another implementation, the geophysical data may correspond to data acquired at the one of the receiver locations due to a source at the source location. In yet another implementation, the source location may be adjacent to at least one of the receiver locations such that the boundary sources may be arranged in one or more substantially linear shapes substantially parallel to the receiver locations. In yet another implementation, the ground roll in the estimate of the ground roll between the source location and the boundary source locations may be a direct ground roll. In yet another implementation, the ground rolls in the estimates of the ground rolls between the one of the receiver locations and the boundary source locations may be scattered ground rolls.

In yet another implementation, the method for processing geophysical data may include generating a model from geophysical data acquired at a receiver location and one or more boundary receiver locations such that the receiver location and the one or more boundary receiver locations may include a cluster of receivers. After generating the model, the method may apply a forward modeling algorithm using information from the model to generate an estimate of a ground roll between the receiver location and the boundary receiver locations. The method may then include determining an estimate of a ground roll between a source location and the boundary receiver locations. After determining the estimate of the ground roll, the method may include applying interferometry between the estimate of the ground roll between the source location and the boundary receiver locations and the estimate of the ground roll between the receiver location and the boundary receiver locations to generate an interferometric estimate of a ground roll between the source location and the receiver location. The method may then include removing the interferometric estimate of the ground roll between the source location and the receiver location from geophysical data acquired at the receiver location. The method described in this paragraph may be performed by a computer-readable medium or a computer system that has a processor, a memory and program instructions configured to perform the method.

In yet another implementation, the source location may be part of a subset of a plurality of source locations arranged in a substantially grid pattern. In yet another implementation, the receiver location and the boundary receiver locations may be arranged in a substantially grid pattern. In yet another implementation, the boundary receiver locations may be arranged in one or more closed geometry configurations such that the boundary receiver locations form two or more concentric shapes. In yet another implementation, the boundary receiver locations may be arranged in one or more open geometry configurations. In yet another implementation, the distance between each receiver in the cluster of receivers may be less than the distance between each boundary receiver location. In yet another implementation, the ground roll in the estimate of the ground roll between the source location and the boundary source locations may be a direct ground roll. In yet another implementation, the ground roll in the estimate of the ground roll between the source location and the boundary source locations may be a scattered ground roll.

Described herein are implementations of various technologies for a seismic survey. The seismic survey system may include: (1) a plurality of receivers arranged in a substantially linear shape; (2) a first plurality of sources arranged substantially along the same line as the plurality of receivers such that at least one source in the first plurality of sources may be adjacent to at least one of the receivers in the plurality of receivers; and (3) a second plurality of sources arranged in a substantially linear shape and substantially parallel to the plurality of receivers.

In one implementation, the seismic survey system may also include a third plurality of sources arranged in a substantially linear shape and substantially parallel to the plurality of receivers. In yet another implementation, the plurality of receivers may be positioned in between the second plurality of sources and the third plurality of sources.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIGS. 1-7B illustrate schematic diagrams of source and receiver configurations in accordance with implementations of various techniques described herein.

FIG. 8 illustrates a flow diagram of a method for removing ground roll from seismic data in accordance with one or more implementations of various techniques described herein.

FIG. 9 illustrates a computer network into which implementations of various technologies described herein may be implemented.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

The following paragraphs provide a brief description of one or more implementations of various technologies and techniques directed at removing ground roll from seismic data. In one implementation, a method for removing ground roll from seismic data may be performed by a computer application. Initially, the computer application may receive seismic data that was acquired from one or more receivers (R) in a seismic survey. In one implementation, the receivers (R) may be arranged in a substantially grid pattern. Using the seismic data received from the receivers (R), the computer application may generate a model of the earth, for example, a velocity that represents the surface wave propagation velocities, or ground roll, of the earth. The computer application may then apply a forward modeling algorithm to the model of the earth to generate an estimate of the direct ground roll between a specified source (S1) and each boundary source (S).

Next, the computer application may make a simple estimate of the direct and scattered ground roll between a specified receiver (R1) located within the grid pattern receivers (R) and each boundary source (S). The simple estimate of ground roll may be obtained using conventional seismic processing techniques such as frequency-wavenumber filtering, band-pass filtering, time windowing and the like. As such, the simple estimate of ground roll may not suppress the body waves within this estimate. In one implementation, the simple estimate of the direct and scattered ground roll between a specified receiver (R1) and each boundary source (S) may be obtained by applying a band pass filter and time window to the seismic data obtained from each receiver (R) due to each boundary source (S). The computer application may then perform interferometry on the estimate of the direct ground roll between the specified source (S1) and each boundary source (S) and the simple estimate of the direct and scattered ground roll between the specified receiver (R1) and each boundary source (S). As a result, an interferometric estimate of the ground roll between the specified source (S1) and the specified receiver (R1) may be obtained. The computer application may then remove the interferometric estimate of the ground roll between the specified source (S1) and the specified receiver (R1) from seismic data between the specified source (S1) and the specified receiver (R1), thereby removing the ground roll from the seismic data.

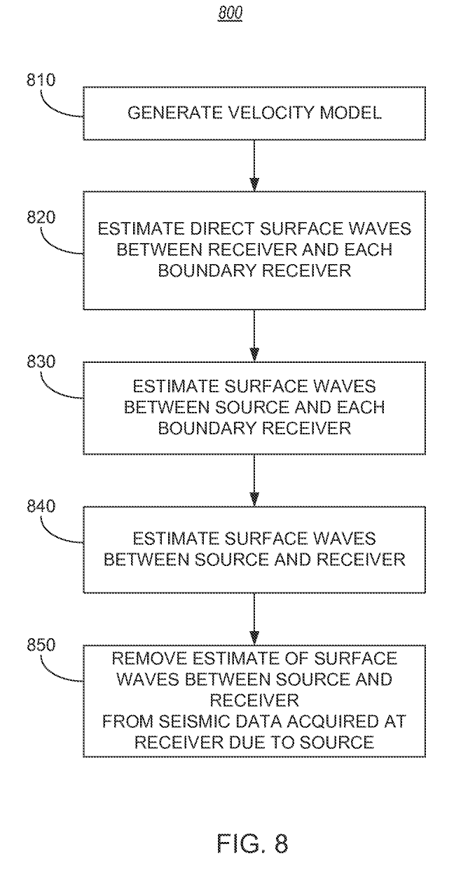

The theory of interferometry used in the process described above is generally based on using a closed geometry of boundary sources. As such, the point of interest (i.e., specified source) may be located inside the closed surface. In one implementation, the point of interest may be located within the closed geometry. However, when parts of a closed geometry are not available, when parts of the closed geometry do not contribute to the ground-roll estimate, or when parts of the closed geometry contribute artifacts to the interferometric estimate, interferometry may not generate an accurate estimate of the ground roll. In these cases, an open geometry of boundary sources may be used to create the interferometric estimate of the ground roll. When using the open geometry of boundary sources, the open geometry should be selected such that that the boundary covers the azimuths used to estimate the ground-roll. Additionally, edge effects from the “open ends” of the open geometry should also be accounted for by using, for example, spatial tapering to diminish the contributions from these end points. Additional details with regard to performing interferometry is provided below with reference to FIG. 8.

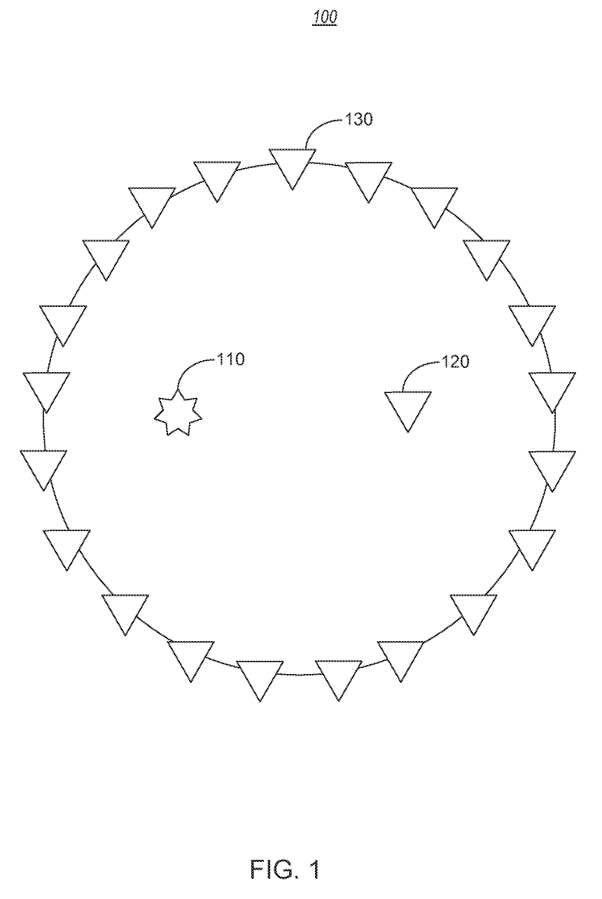

Various techniques for removing ground roll from seismic data will now be described in more detail with reference to FIGS. 1-9 in the following paragraphs.

FIG. 1 illustrates a schematic diagram of a source and receiver configuration 100 in accordance with implementations of various techniques described herein. The source and receiver configuration 100 includes a source 110, a receiver 120 and boundary receivers 130. The source 110 may include any type of seismic source such as a vibrator and the like. The receiver 120 and the boundary receivers 130 may include any type of seismic receivers such as a geophone, hydrophone or the like. Although the source and receiver configuration 100 has been illustrated with boundary receivers 130, according to source-receiver reciprocity, the methods described herein may also be applied to a source and receiver configuration having boundary sources located where the boundary receivers 130 are located, a source located where the receiver 120 is located, and a receiver located where the source 110 is located as per the source and receiver configuration 100.

The source and receiver configuration 100 may be installed on the surface of the earth as part of a land seismic survey or on a seabed as part of an ocean bottom seismic survey. The source 110 may generate a plurality of seismic survey signals in accordance with conventional practice. The seismic survey signals may propagate through the surface of the earth to a geological formation within the earth. The seismic survey signal may then be reflected by a reflector inside the earth. The receiver 120 may receive the reflected signals from the geological formation in a conventional manner. The receiver 120 may then generate data representative of the reflections including the seismic data embedded in electromagnetic signals. The electromagnetic signals may be electrical or optical. The seismic survey signals and the reflections may be comprised of what are known as “body waves,” or waves that propagate into the geological formation of the earth. Body waves may comprise what are more technically known as pressure waves (“P-waves”) and shear waves (“S-waves”).

In addition to the body waves, the source 110 may also generate interface waves, i.e., the ground roll. Note that, in a seabed or ocean bottom survey, the interface waves are Scholte waves. Ground roll propagates, as mentioned above, at the interface between two media, as opposed to through a medium, e.g., layers of the earth. The ground roll may propagate at the interface between the geological formation and the air. The ground roll may then be acquired by receiver 120 along with the body waves. Thus, the data acquired by receiver 120 may also include ground roll data along with body wave data, which may be undesirable. In one implementation, there may be many sources for the ground roll aside from controlled sources like the source 110. As shown in FIG. 1, receiver 120 and source 110 may be positioned inside a circle formed by boundary receivers 130.

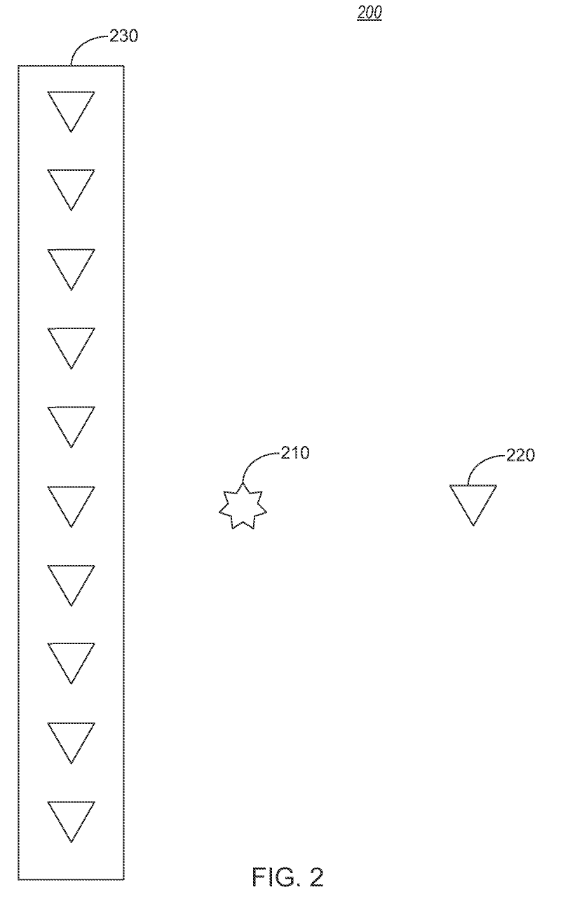

FIG. 2 illustrates a schematic diagram of a source and receiver configuration 200 in accordance with implementations of various techniques described herein. The source and receiver configuration 200 includes a source 210, a receiver 220 and boundary receivers 230. The source 210, receiver 220 and boundary receivers 230 may correspond to the descriptions of source 110, receiver 120 and boundary receivers 130, respectively. Like source and receiver configuration 100, it should be noted that the methods described herein may also be applied to a source and receiver configuration having boundary sources at boundary receiver 230 locations, a source at receiver 220 location, and a receiver at source 210 location according to source-receiver reciprocity.

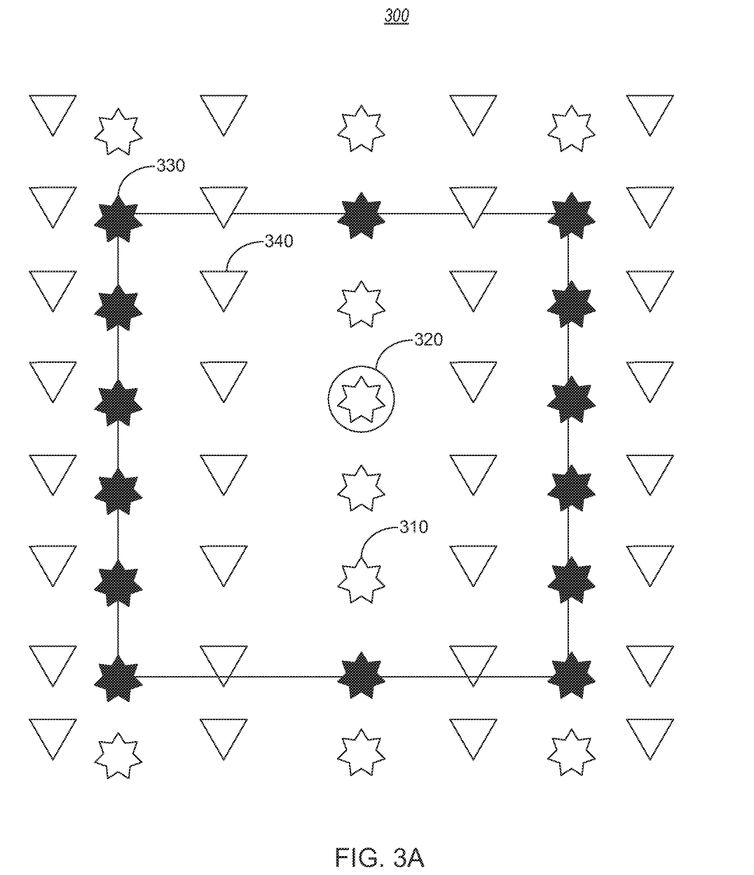

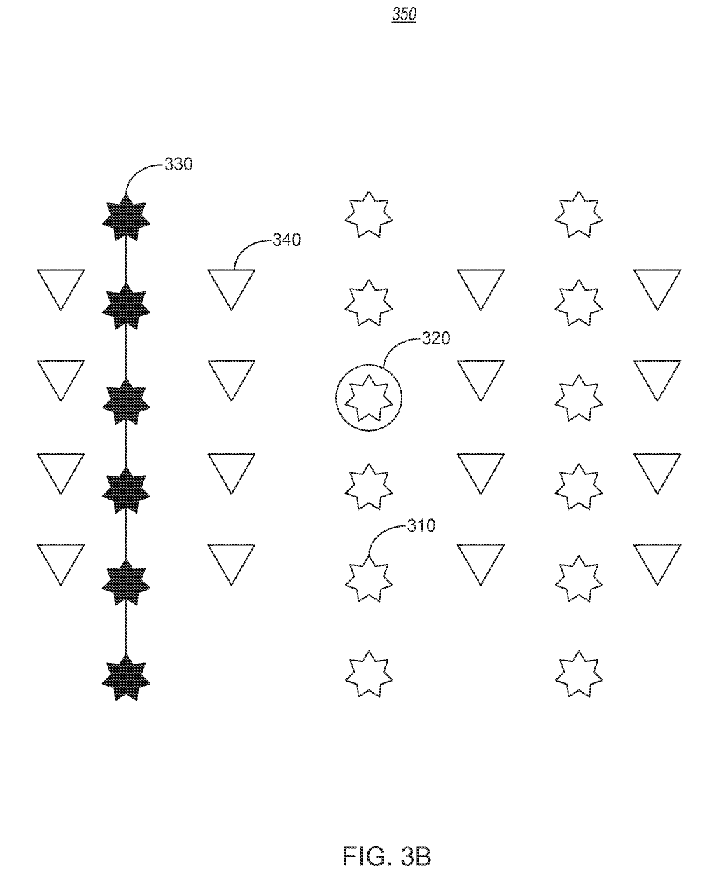

FIG. 3A illustrates a schematic diagram of a source and receiver configuration 300 in accordance with implementations of various techniques described herein. Source and receiver configuration 300 includes sources 310, source of interest 320, boundary sources 330 and receivers 340. Sources 310, source of interest 320, boundary sources 330 correspond to the description of source 110, and receivers 340 correspond to the description of receiver 120, as provided above with reference to FIG. 1. In one implementation, source and receiver configuration 300 may be used to acquire seismic data according to a two-dimensional shot grid. As such, sources 310 and receivers 340 may each be arranged in a grid pattern. However, due to physical obstacles and obstructions that may be present in the survey area, an exact grid pattern may not be possible. As such, grid patterns formed by sources 310 and receivers 340 may form grid patterns that are substantially shaped like grids.

FIG. 3B illustrates a schematic diagram of a source and receiver configuration 350 in accordance with implementations of various techniques described herein. Source and receiver configuration 350 includes sources 310, source of interest 320, boundary sources 330 and receivers 340 which correspond to the descriptions of the same as described above in FIG. 3A. Like in FIG. 3A, sources 310 and receivers 340 may each be arranged in a substantially grid pattern.

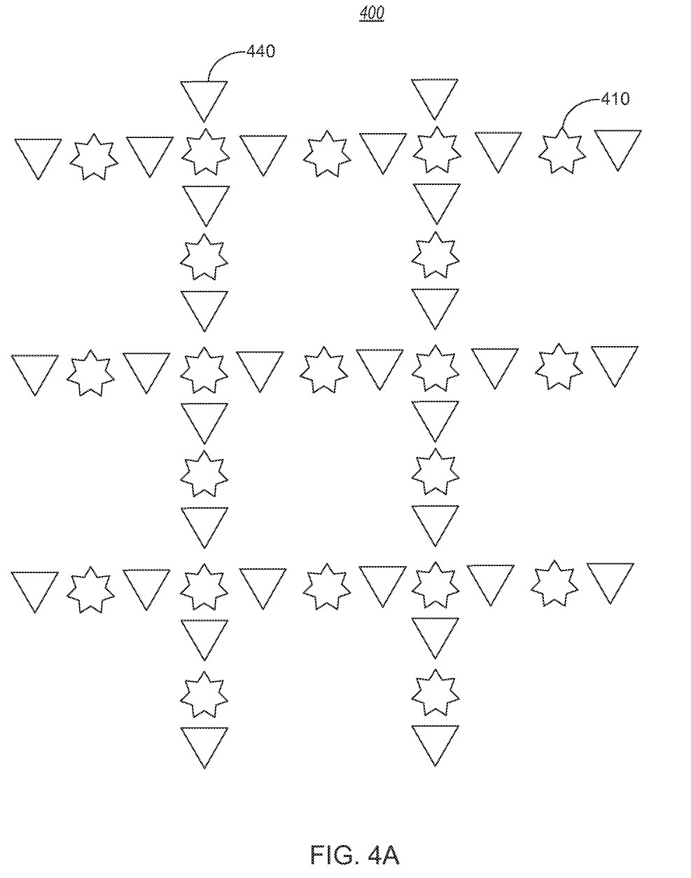

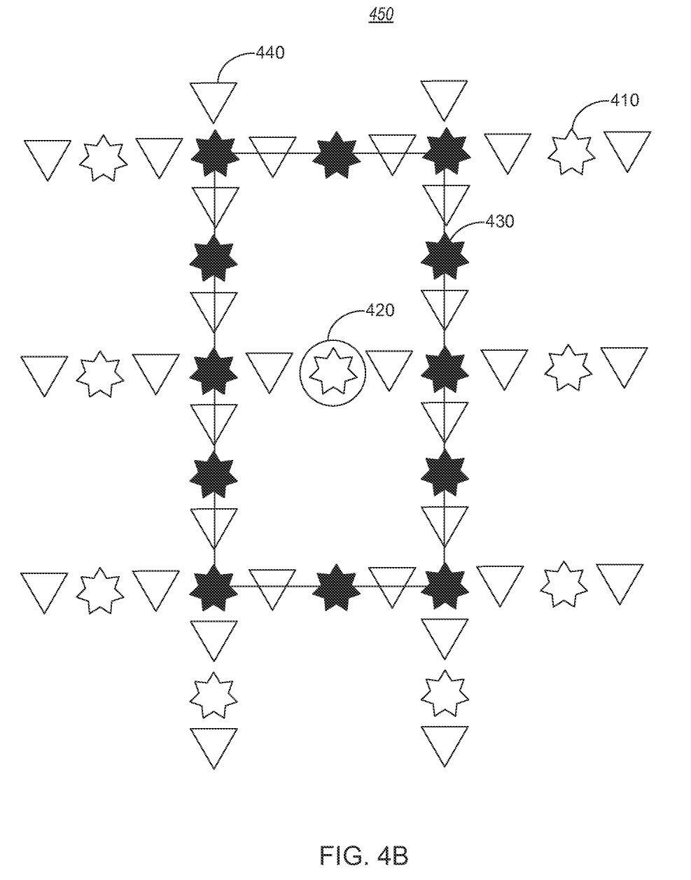

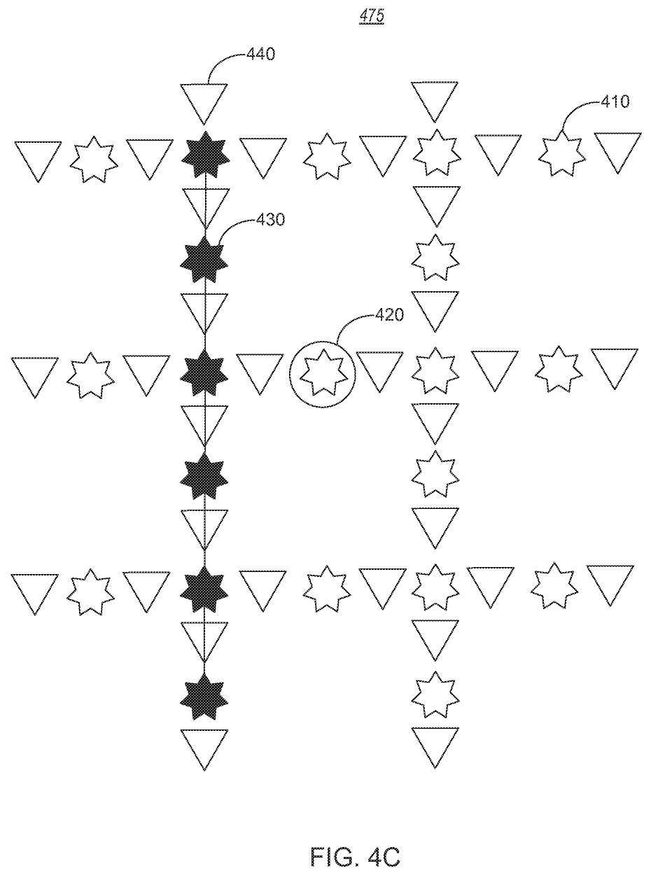

FIG. 4A illustrates a schematic diagram of a source and receiver configuration 400 in accordance with implementations of various techniques described herein. Source and receiver configuration 400 includes sources 410 and receivers 440 which correspond to the descriptions of the source 110 and receivers 120 described above in FIG. 1. Like FIG. 3A, sources 410 and receivers 440 may each be arranged in a substantially grid pattern. In one implementation, source and receiver configuration 400 may be arranged such that the grid pattern of the sources is adjacent to the grid pattern of the receivers. As such, each source 410 may be adjacent to a receiver 440. In this case, sources 410 and receivers 440 may be deployed substantially along the same lines with one set of substantially parallel lines running perpendicular to another set of substantially parallel lines.

Although source and receiver configuration 400 has been described as having each source 410 positioned adjacent to a receiver 440, in other implementations sources 410 may be positioned next to other sources, multiple receivers, empty space and the like.

FIG. 4B illustrates a schematic diagram of a source and receiver configuration 450 in accordance with implementations of various techniques described herein. Source and receiver configuration 450 includes sources 410, source of interest 420, boundary sources 430 and receivers 440 which correspond to the descriptions of the same described above in FIG. 4A.

FIG. 4C illustrates a schematic diagram of a source and receiver configuration 475 in accordance with implementations of various techniques described herein. Source and receiver configuration 475 includes sources 410, source of interest 420, boundary sources 430 and receivers 440 which correspond to the descriptions of the same described above in FIG. 4A.

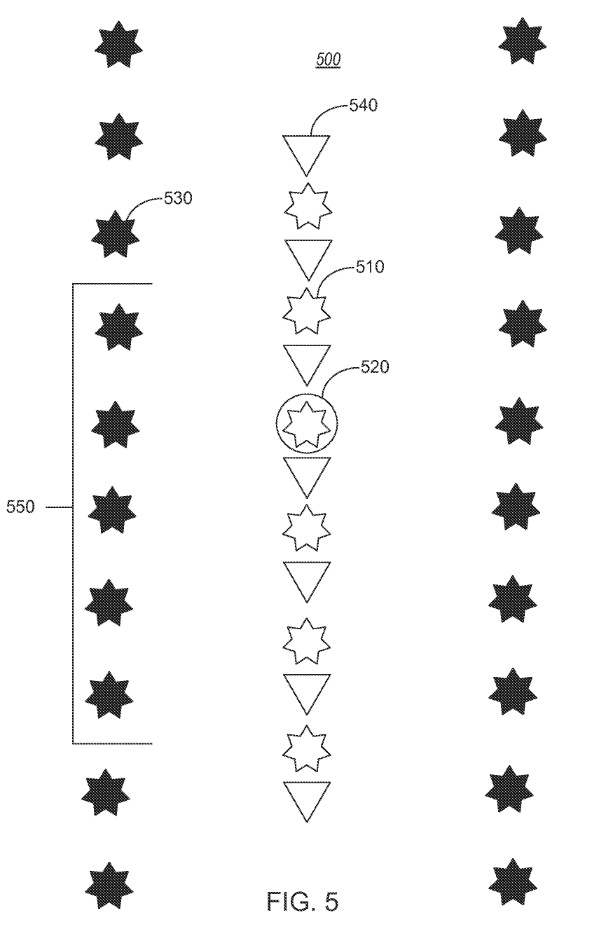

FIG. 5 illustrates a schematic diagram of source and receiver configuration 500 in accordance with implementations of various techniques described herein. Source and receiver configuration 500 includes sources 510, source of interest 520, boundary sources 530 and receivers 540 which correspond to the descriptions of the same described above in FIG. 3A. Sources 510 and receivers 540 may each be arranged in a substantially linear-pattern such that each source 510 may be adjacent to a receiver 540. Although source and receiver configuration 500 has been described as having each source 510 positioned adjacent to a receiver 540, in other implementations sources 510 may be positioned next to other sources, multiple receivers, empty space and the like.

Source of interest 520 may be one of the sources 510 in the substantially linear pattern. Sources 510 and receivers 540 may be used to generate normal two-dimensional seismic survey data. Boundary sources 530 may be arranged in one or more substantially linear patterns to create one or more open boundaries. As such, boundary sources 530 may be used as one or more open boundaries for the methods described herein. In particular, boundary sources 530 may be used as one or more open boundaries for the application of a model-driven interferometry to attenuate cross-line scattered ground-roll from the seismic data. In one implementation, a portion 550 of boundary sources 530 may be used to create the one or more open boundaries.

In another implementation, boundary sources 530 may be substantially parallel with the substantially linear pattern created by sources 510 and receivers 540. Additionally, boundary sources 530 may be configured into two substantially linear patterns of boundary sources 530. These two substantially linear patterns of boundary sources 530 may be positioned adjacent to the substantially linear pattern created by sources 510 and receivers 540. In one implementation, the substantially linear pattern created by sources 510 and receivers 540 may be positioned in between the two linear patterns of boundary sources 530, as shown in FIG. 5.

Like source and receiver configuration 100, it should be noted that the methods described herein may also be applied to a source and receiver configurations 300, 350, 450, 475, 500 having boundary receivers at the boundary source locations and the receiver of interest at the source of interest location according to source-receiver reciprocity.

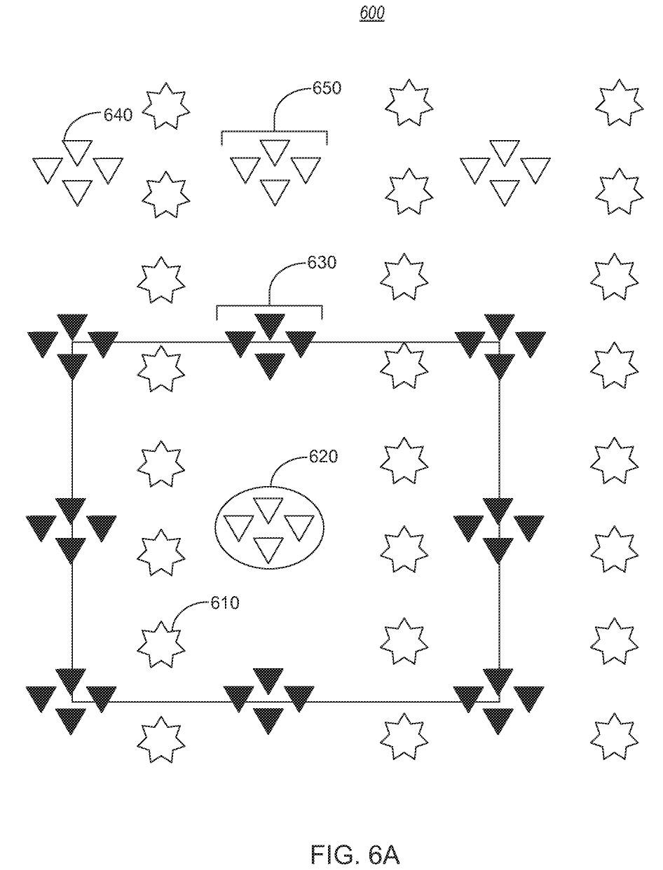

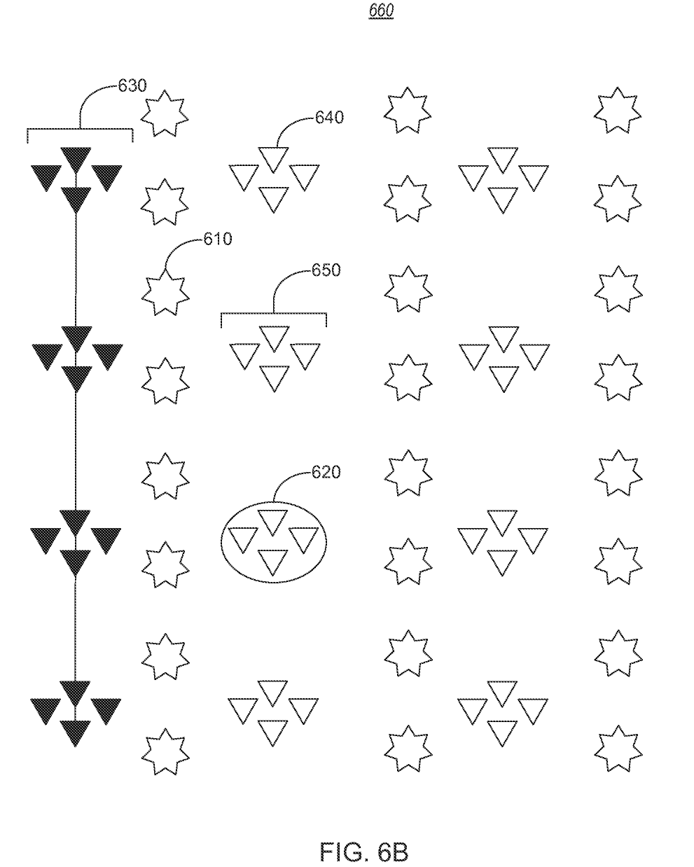

FIG. 6A illustrates a schematic diagram of a source and receiver configuration 600 in accordance with implementations of various techniques described herein. Source and receiver configuration 600 includes sources 610 and receivers 640, which correspond to the descriptions of source 110 and receiver 120, as described in FIG. 1. Source and receiver configuration 600 may also include a receiver node of interest 620, boundary receiver nodes 630 and receiver nodes 650. A node may include a cluster of two or more receivers that are located within a close proximity to each other. Each receiver in a cluster may be located at a predetermined distance from each other such that the predetermined distance is less than the distance between each node. As shown in FIG. 6A, sources 610 and receiver nodes 650 may be arranged in a substantially grid pattern.

FIG. 6B illustrates a schematic diagram of a source and receiver configuration 660 in accordance with implementations of various techniques described herein. Source and receiver configuration 660 includes sources 610, receiver node of interest 620, boundary receiver nodes 630, receivers 640 and receiver nodes 650, which correspond to the descriptions of the same as described above in FIG. 6A.

7A illustrates a schematic diagram of a source and receiver configuration 700 in accordance with implementations of various techniques described herein. Source and receiver configuration 700 includes sources 710, source of interest 720, boundary sources 730, receivers 740 and receiver nodes 750, which correspond to the descriptions of source 110 and receiver 120, as described in FIG. 1. Sources 710 and receiver nodes 750 may each be arranged in a substantially grid pattern, as described in FIGS. 6A-6B.

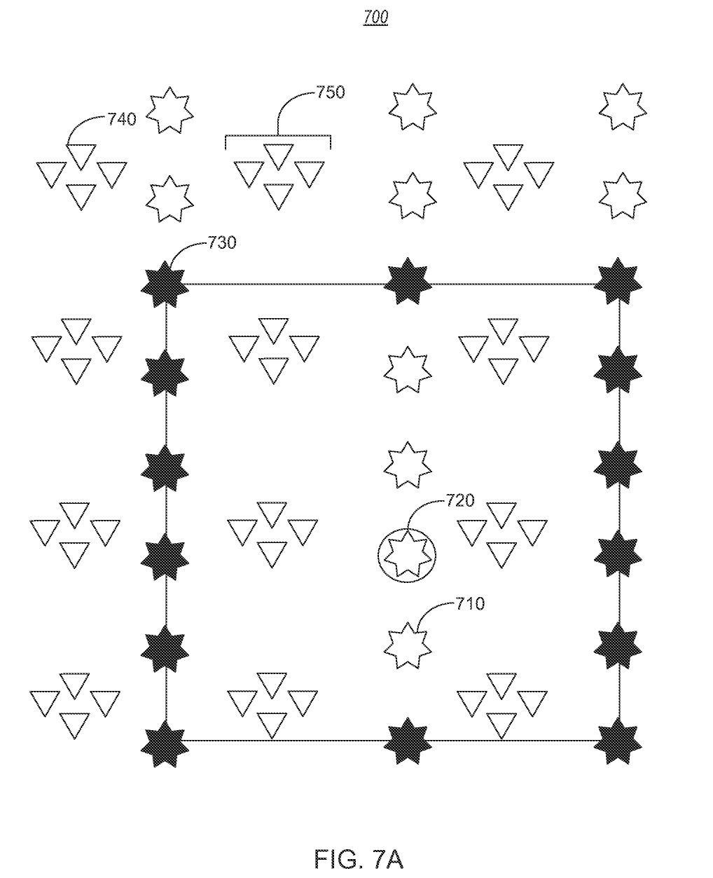

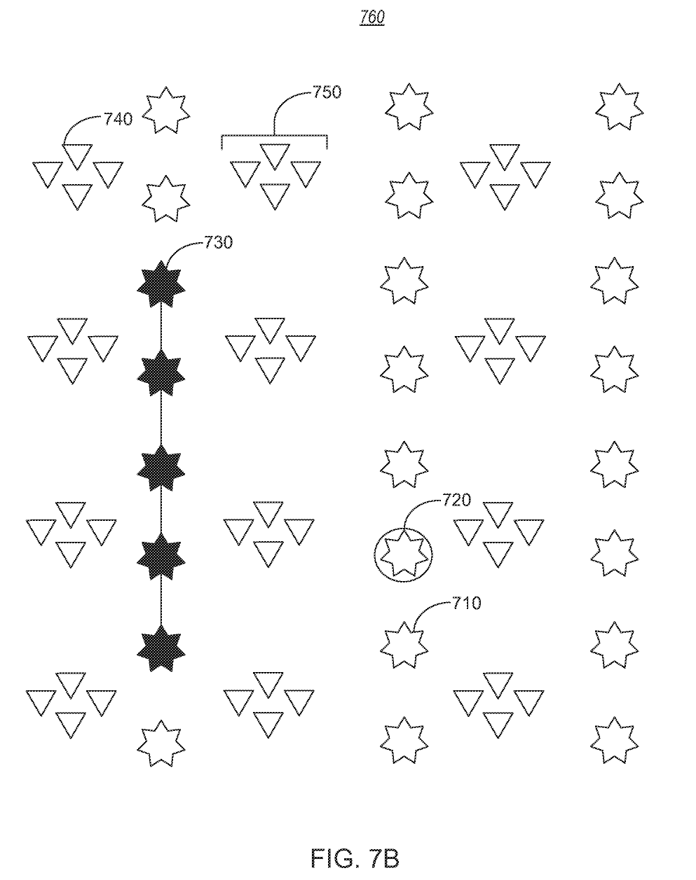

FIG. 7B illustrates a schematic diagram of a source and receiver configuration 760 in accordance with implementations of various techniques described herein. Source and receiver configuration 760 includes sources 710, source of interest 720, boundary sources 730, receivers 740 and receiver nodes 750.

With regard to the boundary sources illustrated in FIGS. 3A, 4B, 6A and 7A, it should be noted that in one implementation, the boundary sources may form a single closed geometrical shape like a square or a rectangle. The closed geometrical shape may be formed using a subset of all of the sources in the survey area. Although the boundary sources have been described as forming a single closed geometrical shape, in other implementations the boundary sources may be used to form multiple closed geometrical shapes. For example, the boundary sources in FIGS. 3A, 4B, 6A and 7A may form multiple concentric shapes. By forming multiple closed geometrical shapes with the boundary sources, the results of the method for removing ground roll described below in FIG. 8 may be improved based on the additional data received from the additional boundary sources.

Similarly, with regard to the boundary sources illustrated in FIGS. 3B, 4C, 6B and 7B, it should be noted that in one implementation, the boundary sources may form a substantially linear shape. The open geometrical shape may be formed using a subset of all of the sources in the survey area. Although the boundary sources have been described as forming a single open geometrical shape, in other implementations the boundary sources may be used to form multiple open geometrical shapes. For instance, the boundary sources may form multiple linear shapes that are substantially parallel with each other. By forming multiple open geometrical shapes with the boundary sources, the results of the method for removing ground roll described below in FIG. 8 may be improved based on the additional data received from the additional boundary sources.

FIG. 8 illustrates a flow diagram of a method 800 for removing ground roll from seismic data in accordance with one or more implementations of various techniques described herein. In one implementation, the method for removing ground roll from seismic data may be performed by a computer application. It should be understood that while the flow diagram indicates a particular order of execution of the operations, in some implementations, certain portions of the operations might be executed in a different order. For purposes of discussing method 800, the following steps of method 800 will be described with reference to the source and receiver configuration 100 of FIG. 1. However, method 800 is not limited to the source and receiver configuration of FIG. 1; instead it should be understood that method 800 may be used in a variety of source and receiver configurations such as those shown in FIGS. 3A-7B.

Generally, the seismic data acquired by receivers 120 in source-receiver configuration 100 may include a seismic wavefield that is composed of three parts: (1) the direct ground roll that propagate between source and receiver locations unaffected by near-surface heterogeneity; (2) the scattered ground roll that propagates between source and receiver locations via near-surface heterogeneities; and (3) the body waves that propagate between source and receiver locations, including reflected waves, multiple reflections, diffractions, refracted waves, and the like. As such, method 800, described herein, may be used to isolate the body waves in (3) by eliminating the contribution of the direct ground roll in (1) and the scattered ground roll in (2). While the separation of the waves in the direct ground roll in (1) from the scattered ground roll in (2) and the body waves in (3) can be achieved using conventional processing techniques, the separation of the scattered ground roll in (2) from the body waves in (3) may not be straightforward.

Conventional processing techniques can be used to make simple estimates of the ground roll in (1) and (2) by band-pass filtering the seismic data, and muting any early arrivals that can be identified as not being ground roll. While this result contains those body waves in (3), this is an appropriate guess of the ground roll for the application of interferometry to create an interferometric estimate of the ground roll. Conventional approaches to interferometric ground-roll remove uses simple estimates of the waves in (1), and (2) to create an estimate of the ground roll that is used to isolate the body waves in (3) by adaptively subtracting the estimates from the seismic data. Method 800, as described below, may replace the direct waves in (1), used as an input to interferometric processing techniques, with waves modeled using a simple forward modeling algorithm thereby making the separation of the waves in the ground roll in (1) and (2) from the body waves in (3) less complex and more straightforward than conventional processing techniques, which often only separate the waves in (1), and not those in (2).

At step 810, the computer application may generate a velocity model from the seismic data acquired at receiver 120 and boundary receivers 130. The seismic data may include the seismic data received at receiver 120 and boundary receivers 130 after source 110 has been actuated. Alternatively, the seismic data may include seismic data acquired at receiver 120 and boundary receivers 130 due to ambient sources within the earth. In any case, the velocity model may represent elastic properties of the near surface of the earth such as ground roll propagation velocities and the like. In one implementation, the computer application may generate the velocity model by extracting a velocity model from the seismic data received at receiver 120 and boundary receivers 130. Although the velocity model has been described as being generated using an extraction process, it should be noted that in other implementations the velocity model may be generated by studying geological maps, analyzing images from various types of satellite, and the like. Further, although method 800 is described using a velocity model, it should be understood that method 800 is not limited to velocity models; instead, any model representing elastic properties of the earth may be used in place of the velocity models used herein. Although method 800 is described herein as removing ground roll from seismic data using seismic data acquired at receivers, it should be understood that method 800 is not limited to only seismic data but may be used for other types of geophysical data.

At step 820, the computer application may apply a forward modeling algorithm using information from the velocity model to generate a modeled estimate of the direct ground roll between receiver 120 and each boundary receiver 130. Here, the computer application may apply the forward modeling algorithm to information extracted from the velocity model. In one implementation, if the seismic data has been received from a source and receiver configuration as shown in FIG. 2 (i.e., orthogonal array of receivers) or any other “open” geometry receiver configuration, the computer application may apply a weighting function to the modeled estimate of the direct ground roll between receiver 220 and each boundary receiver 230. The weighting function may suppress edge effects that may be present in the interferometric estimate of the direct and scattered ground roll between source 210 and receiver 220 determined at step 840 below due to the open geometry configuration of boundary receivers 230.

By obtaining the modeled estimate of the direct ground roll between receiver 120 and each boundary receiver 130 using a forward modeling algorithm, the computer application may be able to apply interferometry between a real source and a real receiver rather than applying interferometry between two receiver locations as is normally the case with seismic interferometry. In one implementation, the estimate of the direct ground roll may be from a near-surface model, which may be a modeled estimate derived from Rayleigh-wave inversions, or any other near-surface characterization study

In yet another implementation, the computer application may generate a velocity model, at step 810, by identifying properties of the direct ground roll within a particular window, such as the ground-roll propagation velocities, the amplitudes of the ground roll, and/or the frequency content of the ground roll. The computer application may then use an appropriately weighted plane wave model of the waves propagating between receiver 120 and boundary receivers 130 to determine the estimate of the direct ground roll between receiver 120 and each boundary receiver 130 using the forward modeling algorithm. By using an appropriately weighted plane wave model of the waves, it is understood that the plane waves are weighted by some factor. For example, these weights may be found from the amplitudes of the data, or by finding those weights that give the most desirable result. By using a plane wave model, the computer application may decrease the computational power needed to determine the estimate of the direct ground roll between receiver 120 and each boundary receiver 130 using the forward modeling algorithm.

In still another implementation, the computer application may use wavefield extrapolation operators, such as those used in seismic migration, to produce similar results to modeling the direct ground roll between receiver 120 and each boundary receiver 130.

At step 830, the computer application may make a simple estimate the direct and scattered ground roll between source 110 and each boundary receiver 130. In one implementation, the direct and scattered ground roll may be estimated by processing the seismic data acquired at boundary receivers 130 due to source 110. The seismic data processing may include applying a band pass filter on the seismic data, analyzing the arrival times of the seismic data via time windowing, or the like.

In one implementation, if the seismic data has been acquired from a source and receiver configuration as shown in FIG. 2 (i.e., orthogonal array of receivers) or any other “open” geometry receiver configuration, the computer application may apply a spatial taper to the simple estimate of the direct and scattered ground roll between source 210 and each boundary receiver 230 to suppress edge effects in the interferometric estimate of the ground roll between source 210 and receiver 220 as determined at step 840 below. The edge effects may occur due to the open geometry configuration of the boundary receivers 230. It should be noted that step 830 is an optional step in method 800, and in some implementations the computer application may proceed to step 840 in lieu of step 830.

At step 840, the computer application may apply interferometry between the simple estimate of the direct and scattered ground roll between source 110 and each boundary receiver 130 obtained at step 830 and the modeled estimate of the direct ground roll between receiver 120 and each boundary receiver 130 obtained at step 820. In one implementation, the computer application may apply interferometry by cross correlating the simple estimate of the direct and scattered ground roll between source 110 and each boundary receiver 130 with the modeled estimate of the direct ground roll between receiver 120 and each boundary receiver 130. After cross correlating these two estimates, the computer application may then sum the results of the cross correlations together. As a result, the computer application may obtain an interferometric estimate of the direct and scattered ground roll between source 110 and receiver 120.

Although the interferometry performed in step 840 used a cross correlation technique, in other implementations the interferometry may be performed using a cross-convolution or a deconvolution technique depending on how source 110, receiver 120 and boundary receivers 130 are positioned with respect to each other. For instance, if receiver 120 is positioned outside the circle formed by boundary receivers 130 in source and receiver configuration 100, the computer application may perform interferometry on the estimates using a cross-convolution technique to obtain a more accurate interferometric estimate of the direct and scattered ground roll between source 110 and receiver 120.

In one implementation, in order to estimate all direct and scattered ground roll between source 110 and receiver 120, boundary receivers 130 should be arranged in a closed configuration as shown in FIG. 1. However, as mentioned above, if boundary receivers 130 are not in a closed configuration, the computer application may perform various processing steps (e.g., apply weighting function, apply spatial taper) at various steps in method 800 to compensate for edge effects that may be present in the interferometric estimate of the direct and scattered ground roll between source 110 and receiver 120 determined at step 840 due to the open geometry configuration of boundary receivers 130.

In still another implementation, method 800 may be configured to estimate just the direct ground roll between source 110 and receiver 120. In this case, after estimating the direct and scattered ground roll between source 110 and each boundary receiver 130 at step 830, the computer application may isolate the direct ground roll from the simple estimate of the direct and scattered ground roll between source 110 and each boundary receiver 130. As a result, at step 840, the computer application may apply interferometry between the simple estimate of the direct ground roll between source 110 and each boundary receiver 130 obtained at step 830 and the modeled estimate of the direct ground roll between receiver 120 and each boundary receiver 130 obtained at step 820 to obtain an interferometric estimate of the direct ground roll between source 110 and receiver 120 at step 840.

In still another implementation, method 800 may be configured to estimate just the scattered ground roll between source 110 and receiver 120. In this case, after estimating the direct and scattered ground roll between source 110 and each boundary receiver 130 at step 830, the computer application may isolate the scattered ground roll from the simple estimate of the direct and scattered ground roll between source 110 and each boundary receiver 130. As a result, at step 840, the computer application may apply interferometry between the simple estimate of the scattered ground roll between source 110 and each boundary receiver 130 obtained at step 830 and the modeled estimate of the direct ground roll between receiver 120 and each boundary receiver 130 obtained at step 820 to obtain an interferometric estimate of the scattered ground roll between source 110 and receiver 120 at step 840.

As mentioned above, step 830 is optional and the computer application may skip step 830 and proceed to step 840 from step 820. In this case, the computer application may apply interferometry between the seismic data between source 110 and each boundary receiver 130 (i.e., seismic data received at boundary receivers 130 due to source 110) and the modeled estimate of the direct ground roll between receiver 120 and each boundary receiver 130 obtained from step 820.

At step 850, the computer application may remove the interferometric estimate of the direct and scattered ground roll between source 110 and receiver 120 from the seismic data acquired at receiver 120 due to source 110. By removing the interferometric estimate of the direct and scattered ground roll between source 110 and receiver 120 from the seismic data acquired at receiver 120, the computer application may reduce or eliminate the ground roll from the seismic data acquired at receiver 120.

In one implementation, if the seismic data received at any of the receivers include two or more distinct ground roll modes that overlap in the frequency domain, the computer application may separate the ground roll modes prior to step 840 and then add their contributions to the estimated direct and scattered ground roll between source 110 and receiver 120 between steps 840 and 850.

In another implementation, when acquiring data using source and receiver configurations 600 or 660, it may be preferable to perform method 800 in the common node domain. In this manner, the boundary may be considered to be composed of nodes, as opposed to receivers.

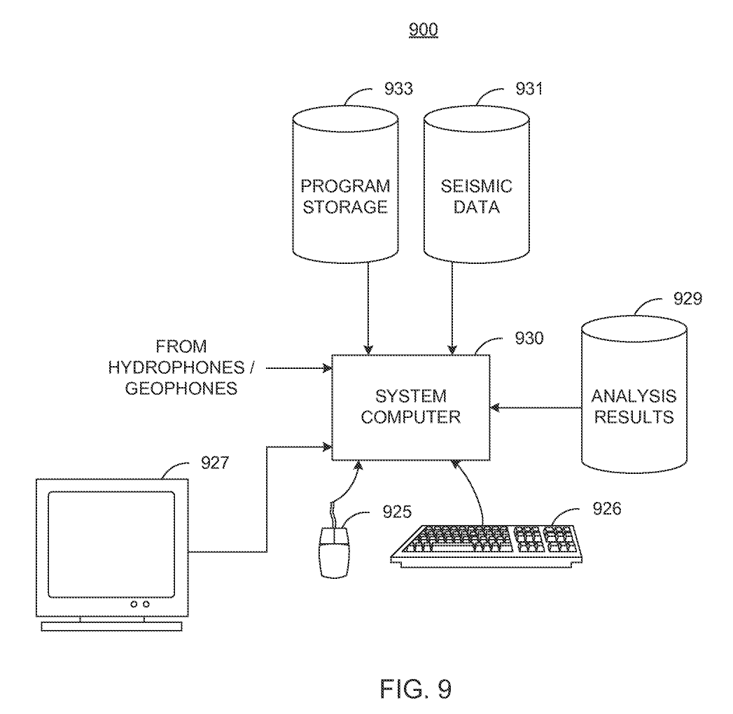

FIG. 9 illustrates a computer network 900 into which implementations of various technologies described herein may be implemented. In one implementation, various techniques for determining the removing ground roll from seismic data as described in FIG. 8 may be performed on the computer network 900. The computer network 900 may include a system computer 930, which may be implemented as any conventional personal computer or server. However, it should be understood that implementations of various technologies described herein may be practiced in other computer system configurations, including hypertext transfer protocol (HTTP) servers, hand-held devices, multiprocessor systems, microprocessor-based or programmable consumer electronics, network PCs, minicomputers, mainframe computers, high-performance clusters of computers, co-processing-based systems (GPUs, FPGAs) and the like. In one implementation, the computer application described in method 800 may be stored on the system computer 930.

The system computer 930 may be in communication with disk storage devices 929, 931, and 933, which may be external hard disk storage devices. It is contemplated that disk storage devices 929, 931, and 933 are conventional hard disk drives, and as such, will be implemented by way of a local area network or by remote access. Of course, while disk storage devices 929, 931, and 933 are illustrated as separate devices, a single disk storage device may be used to store any and all of the program instructions, measurement data, and results as desired.

In one implementation, seismic data from the receivers may be stored in disk storage device 931. The system computer 930 may retrieve the appropriate data from the disk storage device 931 to process seismic data according to program instructions that correspond to implementations of various technologies described herein. Seismic data may include pressure and particle velocity data. The program instructions may be written in a computer programming language, such as C++, Java and the like. The program instructions may be stored in a computer-readable memory, such as program disk storage device 933. Such computer-readable media may include computer storage media and communication media.

Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 900.

Communication media may embody computer readable instructions, data structures or other program modules. By way of example, and not limitation, communication media may include wired media such as a wired network or direct-wired connection, and wireless media such as acoustic, RF, infrared and other wireless media. Combinations of the any of the above may also be included within the scope of computer readable media.

In one implementation, the system computer 930 may present output primarily onto graphics display 927. The system computer 930 may store the results of the methods described above on disk storage 929, for later use and further analysis. The keyboard 926 and the pointing device (e.g., a mouse, trackball, or the like) 925 may be provided with the system computer 930 to enable interactive operation.

The system computer 930 may be located at a data center remote from the survey region. The system computer 930 may be in communication with the receivers (either directly or via a recording unit, not shown), to receive signals indicative of the reflected seismic energy. After conventional formatting and other initial processing, these signals may be stored by the system computer 930 as digital data in the disk storage 931 for subsequent retrieval and processing in the manner described above. In one implementation, these signals and data may be sent to the system computer 930 directly from sensors, such as geophones, hydrophones and the like. When receiving data directly from the sensors, the system computer 930 may be described as part of an in-field data processing system. In another implementation, the system computer 930 may process seismic data already stored in the disk storage 931. When processing data stored in the disk storage 931, the system computer 930 may be described as part of a remote data processing center, separate from data acquisition. The system computer 930 may be configured to process data as part of the in-field data processing system, the remote data processing system or a combination thereof. While FIG. 9 illustrates the disk storage 931 as directly connected to the system computer 930, it is also contemplated that the disk storage device 931 may be accessible through a local area network or by remote access. Furthermore, while disk storage devices 929, 931 are illustrated as separate devices for storing input seismic data and analysis results, the disk storage devices 929, 931 may be implemented within a single disk drive (either together with or separately from program disk storage device 933), or in any other conventional manner as will be fully understood by one of skill in the art having reference to this specification.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for processing geophysical data, comprising:
generating a model from geophysical data acquired at one or more receiver locations that are arranged in one or more substantially linear shapes;
applying a forward modeling algorithm using information from the model to generate an estimate of a ground roll between a source location and one or more boundary source locations;
determining one or more estimates of one or more ground rolls between one of the receiver locations and the boundary source locations;
applying interferometry between the estimates of the ground rolls between the one of the receiver locations and the boundary source locations and the estimate of the ground roll between the source location and the boundary source locations to generate an interferometric estimate of a ground roll between the source location and the one of the receiver locations; and
removing the interferometric estimate of the ground roll between the source location and the one of the receiver locations from geophysical data acquired at the one of the receiver locations.

2. The method of claim 1, wherein the boundary source locations are arranged in one or more closed geometry configurations.

3. The method of claim 2, wherein the boundary source locations form two or more concentric shapes.

4. The method of claim 1, wherein the boundary source locations are arranged in one or more open geometry configurations.

5. The method of claim 1, wherein the boundary source locations are arranged in one or more substantially linear shapes.

6. The method of claim 1, wherein the boundary source locations are a subset of a plurality of source locations that are arranged in a substantially grid pattern.

7. The method of claim 6, wherein each source location in the plurality of source locations is adjacent to at least one of the receiver locations.

8. The method of claim 1, wherein each receiver location comprises a cluster of receivers.

9. The method of claim 1, wherein the geophysical data corresponds to data acquired at the one of the receiver locations due to a source at the source location.

10. The method of claim 1, wherein the source location is adjacent to at least one of the receiver locations, and wherein the boundary sources are arranged in one or more substantially linear shapes substantially parallel to the receiver locations.

11. The method of claim 1, wherein the ground roll in the estimate of the ground roll between the source location and the boundary source locations is a direct ground roll.

12. The method of claim 1, wherein the ground rolls in the estimates of the ground rolls between the one of the receiver locations and the boundary source locations are scattered ground rolls.

13. A method for processing geophysical data, comprising:
generating a model from geophysical data acquired at a receiver location and one or more boundary receiver locations, wherein the receiver location and the one or more boundary receiver locations comprise a cluster of receivers;
applying a forward modeling algorithm using information from the model to generate an estimate of a ground roll between the receiver location and the boundary receiver locations;
determining an estimate of a ground roll between a source location and the boundary receiver locations;
applying interferometry between the estimate of the ground roll between the source location and the boundary receiver locations and the estimate of the ground roll between the receiver location and the boundary receiver locations to generate an interferometric estimate of a ground roll between the source location and the receiver location; and
removing the interferometric estimate of the ground roll between the source location and the receiver location from geophysical data acquired at the receiver location.

14. The method of claim 13, wherein the source location is part of a subset of a plurality of source locations arranged in a substantially grid pattern.

15. The method of claim 13, wherein the receiver location and the boundary receiver locations are arranged in a substantially grid pattern.

16. The method of claim 13, wherein the boundary receiver locations are arranged in one or more closed geometry configurations.

17. The method of claim 16, wherein the boundary receiver locations form two or more concentric shapes.

18. The method of claim 13, wherein the boundary receiver locations are arranged in one or more open geometry configurations.

19. The method of claim 13, wherein the ground roll in the estimate of the ground roll between the source location and the boundary source locations is a direct ground roll.

20. The method of claim 13, wherein the ground roll in the estimate of the ground roll between the source location and the boundary source locations is a scattered ground roll.

21. A seismic survey system, comprising:
a plurality of receivers arranged in a substantially linear shape;
a first plurality of sources arranged substantially along the same line as the plurality of receivers, wherein at least one source in the first plurality of sources is adjacent to at least one of the receivers in the plurality of receivers; and
a second plurality of sources arranged in a substantially linear shape and substantially parallel to the plurality of receivers.

22. The seismic survey system of claim 21, further comprising a third plurality of sources arranged in a substantially linear shape and substantially parallel to the plurality of receivers.

23. The seismic survey of system claim 21, wherein the plurality of receivers is positioned in between the second plurality of sources and the third plurality of sources.
